(19) United States
(12) Patent Application Publication
(10) Pub. No.: US 2005/0061672 A1
(43) Pub. Date: Mar. 24, 2005

(54) Surface characterization through pressure-based electroosmosis measurement

(76) Inventor: Norman Lee Burns, Sunnyvale, CA (US)

Correspondence Address: Norman Lee Burns;Silicon Valley Scientific, Inc., 4059 Clipper Ct., Fremont, CA, 94538, US

(21) Appl. No.: 10/947,017

(22) Filed: Sep. 22, 2004

Related U.S. Application Data
(60) Provisional application No. 60/505,465, filed on Sep. 24, 2003.

(51) Int. Cl. G01N 27/27

(52) U.S. Cl. 204/600

(57) ABSTRACT

A need exists for materials characterization methods that assess quality and performance with respect to surface properties. For non-particulate or non-dispersed particulate materials, measurement of electroosmosis is particularly suitable for surface characterization according to zeta potential, charge and composition. The instant invention provides a means to analytically determine electroosmosis in closed or partially-closed systems of specified geometries, e.g., cylindrical or rectangular chamber, by measuring the pressure difference across an area where electroosmosis is induced. If a sample in the chamber whereby electroosmosis is induced constitutes the surface of interest, the measurement provides a means for electrokinetic characterization of the surface and associated surface properties. The method has the advantages of being quick and sensitive compared to prior methods, and allows for characterization of a wide variety of surfaces and materials not allowed for previously, including capillaries, slides, non-dispersed particles, particle beds, permeable monoliths or consolidated aggregates, and modified surfaces thereof.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

This utility patent application incorporates by reference the provisional Patent Application No. 60/505,465 filing date Sep. 24, 2003 and the inventions therein.

### BACKGROUND OF THE INVENTION

This invention relates to a method for measurement of electroosmosis induced at a surface and electrokinetic characterization of the surface thereof. In particular, the instant disclosure pertains to devices and methods for pressure-based measurement of electroosmosis in a closed or partially-closed sample chambers of specified geometries where one or more surfaces of the chamber constitutes the sample surface of interest. Additionally, the chamber may filled with a sample or configured to accommodate measurement on a wide variety of surfaces and test materials

Within many industries there exists a need for surface characterization methods that predict surface quality and predict performance with respect to surface chemical properties. One way surface chemical information can be obtained is through measurement of induced surface electrokinetic effects. The term “electrokinetic” refers to a number of effects that can be induced by application of external forces to a charged interface. These effects include electrophoresis, streaming and sedimentation potential, and electroosmosis. For non-particulate or non-dispersed particulate materials, measurement of electroosmosis is particularly suitable for surface characterization with respect to surface charge, electrostatics, zeta potential, adsorption properties, and functional chemical groups available at the surface. Electroosmosis is a fluid flow that is induced at a charged surface upon application of an electric field. The fluid flow is a result of the electrophoresis of mobile “counter-ion” species in solution immediately adjacent to a charged surface. These counter-ion species are enriched at the surface due to electrostatic attraction to the charged surface. Thus, electroosmosis is related to surface charge. Surface charge, in turn, is related to the density of ionized groups on the surface, originating either from the substrate or from species adsorbed to the surface.

Traditionally, electroosmosis has been measured in an open system by measuring net fluid flow as a function of time and applied electric field strength, or in a closed system through observation and extrapolation of induced electroosmotic fluid velocity profiles using a tracer (Burns 2001). However, these methods are rather insensitive, involved, and time consuming. Recently, Pengra and Wong have shown that an electrokinetic response can be measured in brine-saturated porous media such as rock using low-frequency alternating driving forces (Pengra and Wong 1999). Against this background, the instant invention provides a simple, automatable and sensitive measurement of electroosmosis at a wide variety of surfaces and materials.

### BRIEF SUMMARY OF THE INVENTION

The invention provides a means to measure electroosmosis at a wide variety of sample surfaces and materials in a closed or partially-closed system of specified geometry and hydrodynamic characteristic, i.e., cylindrical capillary or rectangular chamber, by measuring the pressure difference across the area of induced electroosmotic flow upon application of an electric field along the surface of interest. For example, if one or more of the walls of the system where electroosmosis is induced constitutes the surface of interest, the measurement provides a means for electrokinetic characterization of the surface and associated surface properties. The method has the advantages of being quick and sensitive compared to prior methods, and allows for the characterization of a wide variety of surfaces that were previously intractable to measurement using conventional methods.

Below is a description of the theory behind the measurement and examples of measurement in a cylindrical capillary system and at a microscope slide surface.

### BRIEF DESCRIPTION OF THE DRAWINGS

FIG. 1 Coordinate system and general scheme for boundaries of rectangular chamber for description of hydrodynamics in text.

FIG. 2 Schematic of measurement system for pressure-based measurement of electroosmosis in capillaries.

FIG. 3 Pressure response in 150 micron internal diameter, 10 cm length unmodified fused-silica capillary (filled with 1 mM NaCl, 400Vₘₐₓ−10 mHz applied electric field).

FIG. 4 The pH dependence of electroosmosis for a 250 micron internal diameter fused silica capillary against 1 mM HCl/NaCl/NaOH. The solid line corresponds to a 2 acid-site dissociation model fit to the experimental data.

FIG. 5 Exploded view of rectangular chamber assembly for pressure-based measurement of electroosmosis at slide surfaces.

FIG. 6 Schematic of the hydraulic and electrical circuits of the rectangular chamber for pressure-based measurement of electroosmosis at slide surfaces.

FIG. 7 Pressure response for bare borosilicate microscope slide in the electroosmosis chamber (1 mM NaCl, 400Vₘₐₓ−10 mHz electric field).

### DETAILED DESCRIPTION OF THE INVENTION

### Advantages of the Present Invention

The present invention is described herein with particular reference to its use for performing measurement of electroosmosis induced at sample sufaces. As disclosed in detail below, the present invention provides methods for electrokinetic characterization of surfaces. An advantage of the present invention derives from the fact that it is based on pressure measurement and has the potential to be more sensitive than methods used in the past due to the sensitivity of state-of-the-art pressure transducers in current technology.

A further advantage is the ability of the instant invention to characterize surfaces and materials that were previously difficult or impossible, for example extremely small diameter capillaries.

An additional advantage of the present invention is that it is simple and highly automatable compared to previous methods, involving only the measurement of a low voltage pressure transducer signal that is directly proportional to electroosmosis in the sample chamber.

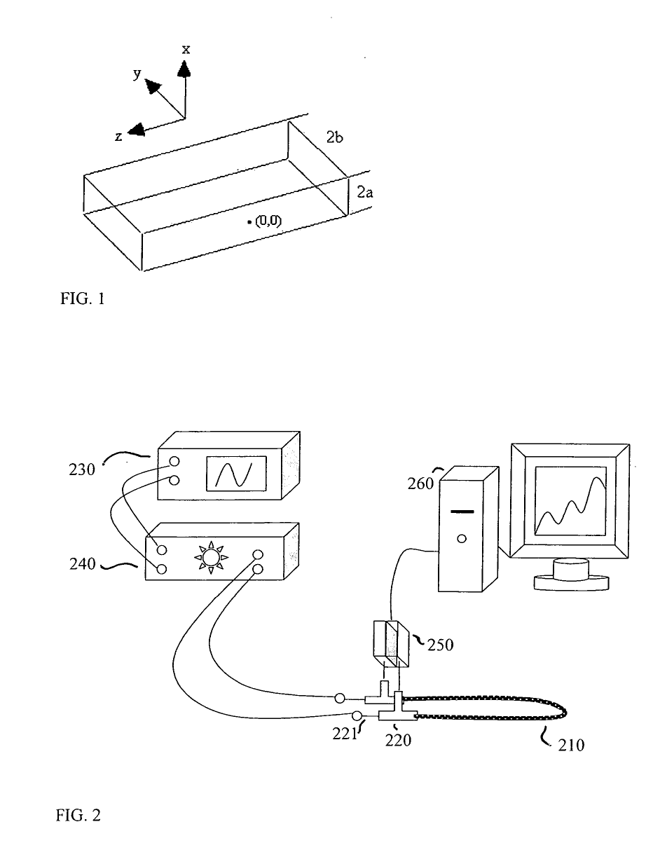

To determine electroosmotic fluid flow at the surface of a sample, a hydrodynamic description of fluid flow in the sample chamber must be determined (Burns 1996). Consider electroosmotic fluid flow induced at the surfaces of a closed rectangular chamber, filled with electrolyte, by a uniform applied electric field of strength E_{z} along the length of the chamber having physical boundaries as in FIG. 1 with the origin of the coordinate system at the center of the sidewall face. With the establishment of steady laminar flow in the chamber a hydrodynamic description of the flow is afforded by the Navier-Stokes equation
η∇²υ−∇p+ρₑE=0 [1]
where η is viscosity, ρ fluid velocity, p pressure, ρₑ charge density, and E the electric field (Russel, et al. 1989).

Considering the larger dimensions of an experimental chamber compared to the thickness of the electrical double layer at the surface (typically μm to nm), fluid flow at the surface would appear to move at a constant velocity. In other words, the region of varying velocity, viscosity, charge density, potential, etc. in the electrical double layer is not observable. Thus viscosity is constant in the bulk hydrodynamic problem. Accordingly, the electrical force term ρₑE in equation 1 can be ignored since the net charge density in the observable region would be zero. It should be noted here, however, that such considerations would appear in any attempt to interpret the source and surface characteristics responsible for the measured electroosmotic velocity, such as interpretation in terms of a zeta potential or the physical properties of the interfacial region (Hunter 1981).

With laminar flow in the z direction we have
υ=υ(x,y)î_{z} [2]
for î_{z} the unit vector along the z-axis, parallel to the applied field, and

$$\frac{\partial p}{\partial x} = \frac{\partial p}{\partial y} = 0 \qquad [ 3 ]$$

Equation 1 may then be written

$$η ( \frac{{\partial }^{2} υ}{\partial {x}^{2}} + \frac{{\partial }^{2} υ}{\partial {y}^{2}} ) - \frac{\partial p}{\partial z} = 0 \qquad [ 4 ]$$

The derivative of equation 4 with respect to z is

$$\frac{{ⅆ}^{2} p}{ⅆ {z}^{2}} = 0 \qquad [ 5 ]$$

of which solution may take the form

$$p = {p}_{0} - ( \frac{Δ p }{l} ) z \qquad [ 6 ]$$

Where p₀ is the the pressure at z=0, Ap the pressure difference between the ends of the chamber, and l the length of the chamber. It also follows from equation 6

$$\frac{ⅆ p}{ⅆ z} = - ( \frac{Δ p}{l} ) \qquad [ 7 ]$$

Thus equation 4 can be rewritten as

$$\frac{{\partial }^{2} υ}{\partial {x}^{2}} + \frac{{\partial }^{2} υ}{\partial {y}^{2}} = \frac{- Δ p}{η l} \qquad [ 8 ]$$

In a closed rectangular system of width 2a and depth 2b (as in FIG. 1) with the upper surface, lower surface and sidewall surfaces possessing differing electrokinetic property, solutions to equation 8 are subject to the following conditions:

$$\begin{matrix}{\int }_{0}^{2 b} {\int }_{- a}^{a} υ ( x , y ) ⅆ x ⅆ y + Δ P = 0 & [ 9 ] \\ υ ( a , y ) = {υ}_{u} & [ 10 ] \\ υ ( - a , y ) = {υ}_{l} & [ 11 ] \\ υ ( x , 0 ) = υ ( x , 2 b ) = {υ}_{s} & [ 12 ]\end{matrix}$$

where υᵤ, υₗ and υₛ are the respective electroosmotic fluid flows induced at the upper, lower, and the sidewall surfaces, and ΔP is the pressure difference across the chamber. Equation 9 follows from the fact that net fluid flow in a closed system is zero, and equations 10-12 from the fact that fluid velocity at the chamber walls correspond to the respective induced electroosmotic flows.

A solution to equation 8 fulfilling the requirements of equations 9-12 with the upper and side walls having negligible electroosmosis may take the form

$${υ}_{l} = Δ P \frac{{a}^{2}}{6 η l} \qquad [ 13 ]$$

which relates a pressure difference in the chamber to the electroosmotic fluid velocity at the lower plate.

Similarly, it can be shown that for cylindrical capillary of radius r and length l the electroosmotic fluid velocity is related to the pressure difference by

$$υ = Δ P \frac{{r}^{2}}{4 η l} \qquad [ 14 ]$$

Equations 13 and 14 express the relations to determine electroosmosis in terms of a pressure difference across closed capillary and rectangular electrophoresis chambers. Furthermore, electroosmosis is directly proportional to the pressure difference for any chamber geometry, and may be determined absolutely for chamber geometries where the proportionality term, may be derived, such as in the specific examples of equations 13 and 14.

To demonstrate the measurement principle, an electroosmotically induced pressure response to an applied electric field was measured in a closed capillary loop in the measurement scheme of FIG. 2. A section of unmodified fused-silica 210 (150 μm internal diameter, 10 cm length, Polymicro Technologies) was augmented with platinum wire electrical connections 221, and pressure measurement connections using a microTee 220 (Upchurch Scientific). The loop and pressure connections were filled with sodium chloride solution of ionic strength 1 mM. An ultra-low frequency alternating current (AC) electric field (400Vₘₐₓ, 10 mHz) was applied across the sample loop. An AC electric field was employed due to unacceptably long times for the hydrodynamic response to reach a steady state using a direct current (DC) field. This observed lag in the pressure response is due to compliance in the system, e.g. in the pressure transducer membrane and the walls of the hydraulic circuit, resulting in a capacitive effect. This capacitive effect is manifest in a frequency dependence in the amplitude pressure response and a shift in phase of the pressure response compared to the electric field (Pengra and Wong 1999). A Wavetek model 395 Waveform Generator 230 was used in the sine wave mode to produce a low voltage AC signal (4Vₘₐₓ, 10 mHz). The low voltage output of the waveform generator was amplified using a bipolar operational power supply/Amplifier 240 (Kepco, model BOP 1000M) to give the high voltage applied field (400Vₘₐₓ, 10 mHz).

The alternating pressure-based electroosmotic response mirroring the applied electric field frequency was measured using a membrane differential pressure transducer 250 (Validyne model P55D-22-2369). The pressure response was continuously measured and collected on a PC 260 using a data acquisition board (National Instruments model 6034E) and supporting LabVIEW software program (Data-Acquisition, VI Technologies).

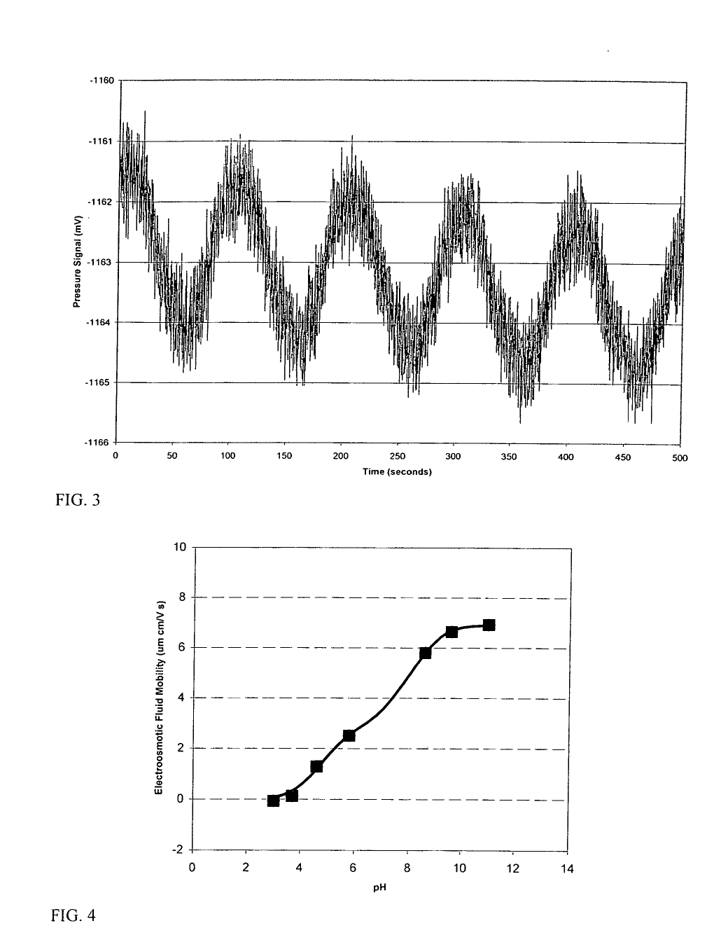

FIG. 3 shows the response from the pressure transducer under measurement. The pressure response is of the same frequency as the driving electric field and has a characteristic amplitude against a constant system background pressure. Thus the response can be modeled by the relation
P=Pₘₐₓ sin (ωt−φ)+P_{background} [15]
where P is the pressure signal at a given time, Pₘₐₓ is the amplitude of the pressure response, ω the angular frequency of the applied AC field, t is time, φ is the phase shift in the pressure response compared to the applied electric field due to the capacitive hydraulic lag, and P_{background} is the constant background pressure upon which the alternating pressure response is superimposed. Pₘₐₓ and φ were taken from a non-linear least squares fit of the pressure response data to equation 15 with reference to the phase of the applied electric field. The fit was accomplished using MATLAB software (The MathWorks, Inc.) employing the FMINS function. This function implements the Nedler-Mead Simplex algorithm for minimizing a nonlinear function of several variables.

As mentioned above, a hydraulic capacitive effect results in a frequency dependence in the amplitude of the response. To correct for this capacitive effect, the pressure amplitude in the limit ω→0, i.e. the pressure difference (ΔP) in the DC limit, is appropriate and can be described by the relation
ΔP=PₘₐₓsecΦ [16]
where Pₘₐₓ and Φ are the pressure amplitude and phase shift, respectively, extracted from the fit to equation 15. Equation 16 is derived from the fact that the pressure lags fluid current in a way analogous to current and voltage in an RC electrical circuit (Pengra and Wong 1999).

Electroosmotic fluid velocity in the capillary was calculated from ΔP using equation 14 and the known values of the capillary radius, capillary length and the viscosity of water.

For the unmodified fused silica example of FIG. 3, the electroosmotic fluid mobility (electroosmotic fluid velocity per unit applied electric field strength) was calculated to be 3.89×10⁻⁸ m²/V s.

As further example of the utility of the method, fused silica capillary was characterized through measurement of the pH dependence of electroosmosis. Such characterization and further analysis in terms of a site-dissociation model of electroosmosis can yield quantitative ionizable surface chemical group density, e.g. silanol density, and dissociation constants of these groups (Burns, et al., 1995).

The pH dependence of the electroosmosis was measured according to the method described above for a 10 cm length fused silica capillary segment of internal diameter 250 micron. Measurement was performed on capillaries filled with solutions of constant 1.00 mM ionic strength at differing pH. The first measurement was performed with 1.00 mM HCl (pH 3) and subsequent measurements were performed with solutions of increasingly higher pH, adjusting pH by addition of 1.00 mM NaCl up to pH 6, and by the addition of 1.00 mM NaOH from pH 6 to 11. A total of 7 measurements were performed at differing pH in approximately one pH unit increments. FIG. 4 shows the pH dependence of the electroosmosis measurements.

The experimental data was analyzed according to nonlinear least-squares fit of the electroosmosis values to a 2 acid-site dissociation model with variable model parameters of acid site density and Bronsted acid site dissociation constant (pKa) (Burns, et al. 1995). The fit yielded quantitative values for two distinct acid sites on the surface of silica, i.e. silanol chemical groups on the surface. An acid group of pKa 4.5 was identified of density 0.18 groups/nm² and second acid group of pKa 7.1 of density 0.45 groups/nm² on the surface. FIG. 4 includes a best fit curve of the site dissociation model to the data. Thus, physicochemical information about specific surface groups can be derived using the instant invention.

The instant invention can also be applied to measure the surface properties of other surfaces including planar surfaces, e.g. slides. Glass microscope slides are commonly used in biotechnology applications as a disposable substrate for immobilization and detection of biological substances, e.g. used in gene expression, protein microarrays, and biosensors. As will be obvious to one skilled in the art, the slide format can also be extended to materials other than glass, comprised of plastic, metal oxide, paper, or any other planar surface. Other types of samples can also be introduced to a slide, e.g. deposited onto a slide or the surface can be physically or chemically modified. Other examples are comprised of modified plastic, fabric, semi-solids, thin-layered materials, electro-deposited materials, adsorbed molecules, paper, filters, biological tissues and cultures, particles and sediments.

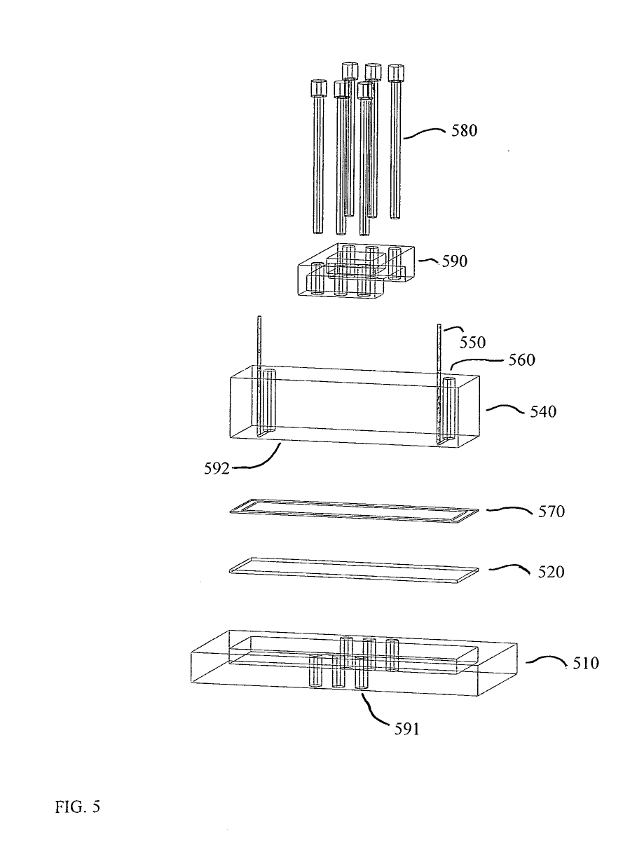

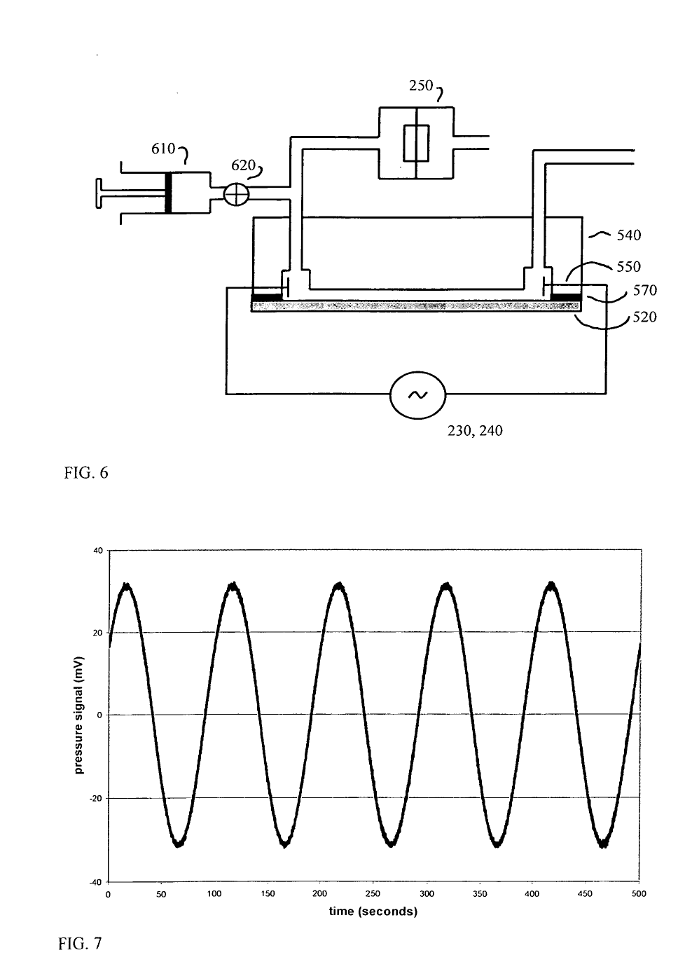

For the slide application, a special rectangular chamber was constructed, as shown in exploded view in FIG. 5. An acrylic block was machined to form a tray 510 to hold a sample plate of dimension 25×75×2 mm³ 520. A second acrylic block 540 was machined to house platinum wire electrodes 550 and pressure transducer connection ports 560. Upon assembly, the electrode block was separated from the sample plate by a Mylar gasket of 10 μm thickness 570. A chamber of dimension 165×570×0.01 mm³ is formed between the sample plate and the face of the acrylic block by clamping the cell together with six screws 580 feeding through an aluminum clamp 590 and screwing into threaded holes 591 in the sample tray 510. FIG. 6 shows a schematic of the electrical and hydraulic circuits of the assembled chamber. A syringe 610 and valve 620 is used to fill the chamber formed by the acrylic block 540, gasket 570, and slide 520. The hydraulic circuit is augmented with a pressure transducer 250 to form a closed-end hydraulic circuit. The backside of the pressure transducer and the open-end of the hydraulic circuit are open to the atmosphere. The electrical circuit is made with electrodes 550 placed at the ends of the acrylic block augmented to a waveform generator 230 and voltage amplifier 240 to create the applied field along the length of the filled chamber.

To eliminate any extraneous electroosmotic fluid flow that may result from surfaces of the chamber other than the sample slide, the face of the acrylic block forming the chamber 592 was modified by grafting a neutral hydrophilic polymer to the surface. The surface of acrylic is known to contain acid groups at the surface from the hydrolysis of the ester side-chains of the polymer (Allcock and Lampe 1990). These acidic carboxylate groups are a potential source of charge and electroosmotic flow. Thus, the surface must be deactivated with respect to surface charge and electroosmosis if measurement at the sample substrate is to be accurate. Surface-localized neutral hydrophilic polymers such as polyethylene glycol (PEG) are known to eliminate electroosmosis and hinder adsorption (Burns et al., 1995). An amine terminal linear PEG of molecular weight 20,000 g/mole (MPEG-amine 20K, Shearwater Polymers) was reacted with the surfaces of the assembled chamber containing an acrylic slide by exposing the surfaces of the chamber overnight at room temperature to a 10% w/w solution of MPEG-amine in 0.05M sodium dihydrogen phosphate and 0.05M ethyl-(3-dimethylaminopropyl)carbodiimide (EDC). The chamber was subsequently rinsed with water. EDC serves to activate carboxyl groups for reaction with the terminal amine group of the PEG-amine to effect a terminal graft of the polymer. Electroosmosis was subsequently measured in 1 mM NaCl and determined to be on the order of 10⁻¹⁰ m²/V s in the modified chamber. This experiment verified that extraneous electrosmotic fluid flows, i.e. flows not originating from the sample slide, were less than 10⁻¹⁰ m²/V s in the modified chamber.

FIG. 7 shows the pressure response for measurement at a borosilicate glass microscope slide (1 mM NaCl, 400Vₘₐₓ−0.1 mHz electric field). Note that the signal-to-noise is much greater for the slide cell due to the fact that the width of the cell is much smaller than that of the capillary measurement example (see equations 13 and 14). For the slide cell this sensitivity allows for determination of electroosmotic fluid mobility down to 10⁻¹¹ m²/V s.

The electroosmotic fluid mobility at the slide surface was calculated using a fit to equation 15 (as in the capillary example), and equations 16 and 14 to give a value of 5.44×10⁻⁸ m² V s.

Thus, the invention has demonstrated to measure the surface characteristic electrokinetic property of electroosmosis for two different sample geometries, i.e. the inner surface of a capillary and the surface of a slide. This invention provides a versatile means to measure the electrokinetic surface properties of many materials and surfaces in a variety of geometries.

References

Norman L. Burns, “Measurement of Electrokinetic Phenomena in Surface Chemistry,” in Handbook of Applied Surface and Colloid Chemistry, ed. Krister Holmberg, John Wiley and Sons (2001).

David B. Pengra and Po-zen Wong, “Low-Frequency AC Electrokinetics,” Colloids and Surfaces A, 159, 283-292 (1999).

Norman L. Burns, “Surface Characterization through Measurement of Electroosmosis at Flat Plates,” J. Colloid Interf. Sci. 183, 249-259 (1996).

William B. Russel, Dudley A. Saville and W. R. Schowalter, Colloidal Dispersions, Cambridge University Press, Cambridge (1989).

Robert J. Hunter, Zeta Potential in Colloid Science, Academic Press, London (1981).

Harry R. Allcocke and Frederick W. Lampe, Contemporary Polymer Chemistry, 2^{nd} Ed., Prentice Hall, New Jersey (1990).

Norman L. Burns, James M. Van Alstine and J. Milton Harris, “Poly(Ethylene Glycol) Grafted to Quartz: Analysis in Terms of a Site Dissociation Model of Electroosmotic Fluid Flow,” Langmuir, 11 (1995).

1. A device for the measurement of electroosmosis whereby electroosmotic fluid flow results in a pressure difference in a closed or partially closed sample chamber that is comprised of:
a. One or more of the surfaces of the sample chamber constitutes the test material of interest, typically but not limited to a glass capillary or slide.
b. Electrodes connected to a power supply to induce the electroosmosis within the test chamber, which is filled with an electrolyte solution.
c. A pressure transducer that measures the pressure difference in the chamber in response to induction of electroosmosis, which is proportional to the zeta potential of the surface to be tested, which in turn is related to surface charge.
d. Means for data acquisition and processing

2. A device as in claim I whereby test materials may be comprised of materials other than glass—e.g., plastic, metal oxides, paper, and virtually any other material for which it is desirable to characterize zeta potential and surface charge characteristics and properties.

3. A device as in claim 1 whereby test materials may be first deposited onto glass or some other surface, or where the glass or other surface has been chemically or physically modified in some fashion, prior to conducting these measurements. Materials deposited onto glass or other surfaces may be biological or non-biological molecules, including but not limited to polymers, gels, proteins, carbohydrates, nucleic acids, etc., as obvious to one skilled in the art. The deposited materials or coat may be of a porous or nonporous nature.

4. A device as in claim 1 whereby the sample chamber may be filled with a non-aqueous solution or liquid, such as a polar or non-polar solvent.

5. A device for the measurement of electroosmosis whereby electroosmotic fluid flow results in a pressure difference in a closed or partially closed sample chamber that is comprised of:
a. Electrodes connected to a power supply to induce the electroosmotic flow within the test chamber which is filled with an electrolyte solution and test materials of interest that are of a particulate nature.
b. The particulate test materials of interest are comprised of, but are not limited to beads, particles, and nanoparticles of various chemical and physical compositions, and which may be either porous or non-porous or have either porous or non-porous surfaces.
c. A pressure transducer that measures the induced pressure change in the chamber which, in response to application of an electrical field, generates electroosmosis proportional to the overall zeta potential of the beads, particles or nanoparticles to be tested.
d. Means for data acquisition and processing

6. A device as in claim 5 to characterize the zeta potential and the charge characteristics of particulate test materials that have been coated or chemically or physically modified with other molecules or materials including biological or non-biological molecules, polymers or gels.

7. A device as in claim 5 whereby the sample chamber may be filled with a non-aqueous solution or liquid, such as other polar and even non-polar solvents.

8. A device as in claim 5 whereby the sample chamber may be filled with a test material comprised of a permeable gel, monolith or consolidated aggregate.

9. A method and formulation for modification of acrylic surfaces with polyethylene glycol to alter the surface properties including wetting, adsorption, charge and control of electrokinetic effects.
